(19) United States
(12) Patent Application Publication
(10) Pub. No.: US 2019/0103093 A1
(43) Pub. Date: Apr. 4, 2019

(54) METHOD AND APPARATUS FOR TRAINING ACOUSTIC MODEL

(71) Applicant: Baidu Online Network Technology (Beijing) Co., Ltd., Beijing (CN)

(72) Inventors: Bin HUANG, Beijing (CN); Xiangang LI, Beijing (CN)

(21) Appl. No.: 16/053,885

(22) Filed: Aug. 3, 2018

(30) Foreign Application Priority Data
Sep. 29, 2017 (CN) 201710911252.3

(51) Int. Cl. G10L 15/06; G10L 15/08; G10L 25/03

(52) U.S. Cl. CPC G10L 15/063; G10L 25/03; G10L 15/08

(57) ABSTRACT

The present disclosure discloses a method and apparatus for training an acoustic model. A specific implementation of the method comprises: removing a high-delay search path from all search paths used in training an acoustic model by using a connectionist temporal classification (CTC) criterion, the high-delay search path being a search path whose state output delay greater than a delay threshold; and training the acoustic model on the basis of a search path whose state output delay smaller than the delay threshold.

### CROSS-REFERENCE TO RELATED APPLICATIONS

This application claims the priority of Chinese Application No. 201710911252.3, filed on Sep. 29, 2017, titled “Method and Apparatus for Training Acoustic Model,” the entire disclosure of which is incorporated herein by reference.

### TECHNICAL FIELD

The present disclosure relates to the field of computers, specifically to the field of voices, and particularly to a method and apparatus for training an acoustic model.

### BACKGROUND

CTC (connectionist temporal classification) criteria are widely applied to training and optimization of acoustic models. During the training of the acoustic models using the CTC criteria, as a large number of high-delay search paths are used in the training, delays of state sequence outputs by the trained acoustic models likely result.

### SUMMARY

The present disclosure provides a method and apparatus for training an acoustic model to solve the technical problems in the background section.

In a first aspect, the present disclosure provides a method for training an acoustic model, and the method includes: removing a high-delay search path from all search paths used in training an acoustic model by using a connectionist temporal classification (CTC) criterion, the high-delay search path being a search path whose state output delay is greater than a delay threshold; and training the acoustic model using search paths among the all search paths having the state output delay smaller than the delay threshold and other than the high-delay search path.

In a second aspect, the present disclosure provides an apparatus for training an acoustic model, and the apparatus includes: a search path removing unit, configured for removing a high-delay search path from all search paths used in training an acoustic model by using a connectionist temporal classification criterion, the high-delay search path being a search path whose state output delay greater than a delay threshold; and an acoustic model training unit, configured for training the acoustic model using search paths among the all search paths having the state output delay smaller than the delay threshold and other than the high-delay search path.

With the method and apparatus for training an acoustic model according to the present disclosure, a high-delay search path is removed from all search paths used in training an acoustic model by using a connectionist temporal classification criterion, the high-delay search path being a search path whose state output delay greater than a delay threshold; and the acoustic model is trained using search paths among the all search paths having the state output delay smaller than the delay threshold and other than the high-delay search path. When the CTC criterion is used to train the acoustic model, the high-delay search path in all search paths is removed, so that the high-delay search path is not used in training the acoustic model, and the problem that a large number of high-delay search paths used in the training of the acoustic model using the CTC criterion may likely cause the delay of the state sequence output by the trained acoustic model is avoided to ensure that the trained acoustic model has a smaller time delay in predicting a voice state.

### BRIEF DESCRIPTION OF THE DRAWINGS

Other features, objects and advantages of the present application may be more apparent by reading a detailed description of the non-limiting embodiments made with reference to the following drawings:

FIG. 1 shows a flow chart of an embodiment of a method for training an acoustic model according to the present disclosure;

FIG. 2 shows a structure diagram of an embodiment of an apparatus for training an acoustic model according to the present disclosure; and

FIG. 3 shows a structure diagram of a computer system of an electronic device suitable for implementing embodiments of the present disclosure.

### DETAILED DESCRIPTION OF EMBODIMENTS

The present disclosure will be further described below in detail in combination with the accompanying drawings and the embodiments. It should be appreciated that the specific embodiments described herein are merely used for explaining the relevant disclosure, rather than limiting the disclosure. In addition, it should be noted that, for the ease of description, only the parts related to the relevant disclosure are shown in the accompanying drawings.

It should also be noted that the embodiments in the present disclosure and the features in the embodiments may be combined with each other on a non-conflict basis. The present disclosure will be described below in detail with reference to the accompanying drawings and in combination with the embodiments.

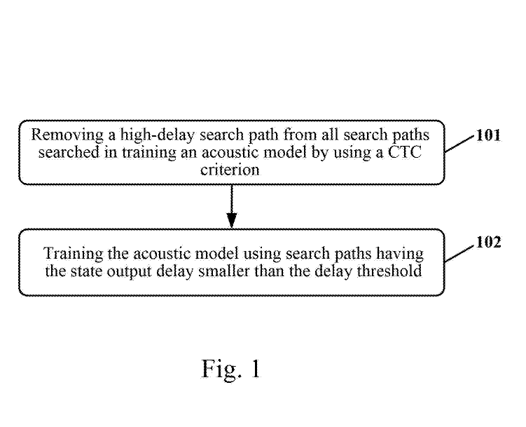

Referring to FIG. 1, FIG. 1 shows a flow of an embodiment of the method for training an acoustic model according to the present disclosure. The method includes steps 101 and 102.

Step 101 includes removing a high-delay search path from all search paths searched in training an acoustic model by using a connectionist temporal classification (CTC) criterion.

When the CTC criterion is used to train the acoustic model, all search paths in a finite state space on a time axis may be traversed, and the all search paths contain the high-delay search path.

For example, a segment of voice in the training of the acoustic model by using the CTC criterion is a voice reading a reference labeling sequence {bei, jing}, and in this segment of voice, after the word “bei” is read, the word “jing” is read after a pause of 5 seconds. For all searched search paths, by mapping state sequences corresponding to multiple search paths, predicted labeling sequences identical to the reference labeling sequence {bei, jing} may be obtained. The search paths whose corresponding state sequences are mapped to obtain the predicted labeling sequence identical to the reference labeling sequence {bei, jing} may include the high-delay search path. For example, the output instant of the word “bei” in the high-delay search path is not shortly after an instant that an audio of a state “bei” is predicted, but may be after an instant that the acoustic model predicts the state “jing”, i.e., the word “bei” is output 5 seconds after being predicted.

During the training of the acoustic model using the CTC criterion, because a large number of high-delay search paths are used in the training process, the delay of the state sequence output by the trained acoustic model is caused. For example, a segment of voice reading “bai du da sha” is entered by a user, after reading “sha,” if a button of voice input is pressed all the time, the optimized search path decoded by the trained acoustic model may only output “bai,” “du,” and “da,” the “sha,” is not outputted until a next state is predicted by the acoustic model, and “sha” may only be outputted after the user releases the button of speech input.

In the present embodiment, in order to avoid the delay of the state sequence output by the trained acoustic model caused by the high-delay search paths used in the training using the CTC criterion, the high-delay search paths in all search paths can be removed when the acoustic model is trained using the CTC criterion.

In some optional implementations of the present embodiment, the high-delay search paths in all search paths used in training the acoustic model using the connectionist temporal classification criterion can be removed by adding a strong delay control constraint to train the acoustic model using the CTC criterion. The strong delay control constraint is used for reserving, from all search paths, a search path whose state output delay is smaller than the delay threshold.

In some optional implementations of the present embodiment, when the acoustic model is trained on the basis of the search path whose state output delay smaller than the delay threshold other than the high-delay search path of all search paths, the CTC criterion can be used to optimize the acoustic model by maximizing a sum of a probability of the search path corresponding to a target sequence in the search path whose state output delay smaller than the delay threshold other than the high-delay search path of all search paths, and the target sequence is a predicted labeling sequence identical to a reference labeling sequence. Therefore, only the search path corresponding to the target sequence in the search path whose state output delay smaller than the delay threshold in all search paths is used in the optimization of the acoustic model.

Step 102 includes training the acoustic model on the basis of the search path whose state output delay smaller than the delay threshold.

In the present embodiment, after removing the high-delay search path from all search paths searched in training the acoustic model by using the CTC criterion in step 101, the acoustic model can be trained on the basis of the search path whose state output delay smaller than the delay threshold other than the high-delay search path in all search paths. When the CTC criterion is used to train the acoustic model, the high-delay search path in all search paths is removed, so that the high-delay search path may not be used in training the acoustic model, and the problem that a large number of high-delay search paths used in the training of the acoustic model using the CTC criterion may likely cause the delay of the state sequence output by the trained acoustic model is avoided to ensure that the trained acoustic model has a smaller time delay in predicting a voice state.

In some optional implementations of the present embodiment, after the acoustic model is trained by using the search path whose state output delay smaller than the delay threshold which is acquired by removing the high-delay search path from all search paths used in training the acoustic model by using the CTC criterion to obtain a trained acoustic model, the trained acoustic model can be used to identify the voice input by the user. The voice input by the user can be received by using the trained acoustic model to determine an optimal search path, and the delay of each state output in the optimal search path is smaller than a delay threshold.

For example, the user enters a segment of voice reading “bai du da sha”, after the last word “sha” is read, each of the output delays of “bai”, “du”, “da” and “sha” in the “bai du da sha” in the optimal search path determined by the trained acoustic model is within the delay threshold when the button of voice input is pressed all the time.

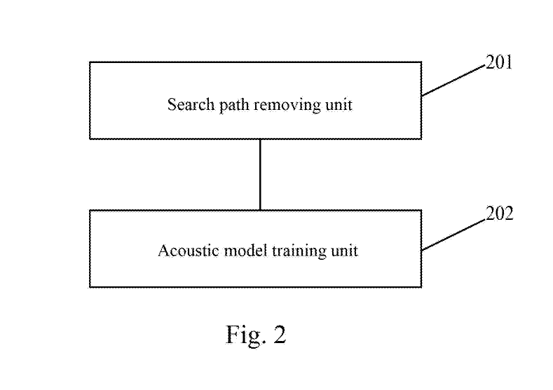

Referring to FIG. 2, as an implementation of the method shown in the FIG. 1, the present disclosure provides an embodiment of an apparatus for training an acoustic model, and the embodiment of the apparatus corresponds to the embodiment of the method shown in FIG. 1.

As shown in FIG. 2, the apparatus for training the acoustic model includes a search path removing unit 201 and an acoustic model training unit 202. The search path removing unit 201 is configured for removing a high-delay search path from all search paths used in training an acoustic model by using a connectionist temporal classification criterion, the high-delay search path being a search path whose state output delay greater than a delay threshold; and the acoustic model training unit 202 is configured for training the acoustic model on the basis of a search path whose state output delay smaller than the delay threshold other than the high-delay search path in all search paths.

In some optional implementations of the present embodiment, the search path removing unit includes: a constraint adding subunit, configured for adding a strong delay control constraint to train the acoustic model by using the connectionist temporal classification criterion, the strong delay control constraint being used for reserving a search path whose state output delay smaller than the delay threshold in all search paths.

In some optional implementations of the present embodiment, the acoustic model training unit includes: an optimizing subunit, configured for optimizing the acoustic model by maximizing, using the connectionist temporal classification criterion, a sum of a probability of a search path corresponding to a target sequence in the search path whose state output delay smaller than the delay threshold, the target sequence being a predicted labeling sequence identical to a reference labeling sequence.

In some optional implementations of the present embodiment, the acoustic model training further includes: an identifying unit, configured for receiving a voice input by a user by using the trained acoustic model and determining an optimal search path, the delay of each state output in the optimal search path being smaller than the delay threshold.

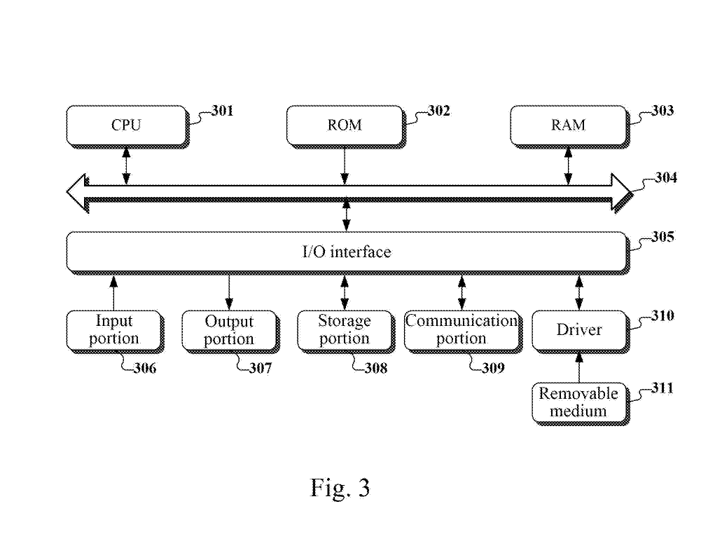

FIG. 3 shows a structure diagram of a computer system of an electronic device suitable for implementing embodiments of the present disclosure.

As shown in FIG. 3, the computer system includes a central processing unit (CPU) 301 that can execute various appropriate actions and processes according to a program stored in a read only memory (ROM) 302 or a program loaded into a random access memory (RAM) 303 from a storage port 308. In the RAM 303, various programs and data required for operations of the computer system are also stored. The CPU 301, the ROM 302, and the RAM 303 are connected to one another through a bus 304. An input/output (I/O) interface 305 is also connected to the bus 304.

The following components are connected to the I/O interface 305: an input port 306, an output port 307, a storage port 308 including a hard disk and the like, and a communication port 309 including network interface cards such as an LAN card and a modem. The communication port 309 executes communication processing through a network such as the Internet. A driver 310 is also connected to the I/O interface 305 as needed. A detachable medium 311, such as a magnetic disk, an optical disk, a magnetooptical disk, and a semiconductor memory, is mounted on the driver 310 as needed to facilitate installation of a computer program read from the detachable medium into the storage port 308 as needed.

In particular, the process described in the embodiments of the present disclosure may be implemented as a computer program. For example, the embodiments of the present disclosure include a computer program product including a computer program carried on a computer readable medium, the computer program including instructions for executing the method shown in the flow diagram. The computer program may be downloaded and installed from a network through the communication port 309 and/or installed from the detachable medium 311. When the computer program is executed by the central processing unit (CPU) 301, the above-mentioned functions defined in the method of the present disclosure are executed.

The present disclosure also provides an electronic device which can be configured with one or more processors, and a memory for storing one or more programs that may include instructions for executing the operations described in steps 101-102. When the one or more programs are executed by the one or more processors, the one or more processors can execute the operations described in steps 101-102.

In another aspect, the present disclosure further provides a computer-readable medium. The computer-readable medium may be included in the electronic device, or a stand-alone computer-readable medium not assembled into the electronic device. The computer-readable medium stores one or more programs. The one or more programs, when executed by electronic device, cause the electronic device to: remove a high-delay search path from all search paths searched in training an acoustic model by using a connectionist temporal classification criterion, the high-delay search path being a search path whose state output delay greater than a delay threshold; and train the acoustic model on the basis of a search path whose state output delay smaller than the delay threshold other than the high-delay search path of all search paths.

It should be noted that the computer readable medium in the present disclosure may be computer readable signal medium or computer readable storage medium or any combination of the above two. An example of the computer readable storage medium may include, but not limited to: electric, magnetic, optical, electromagnetic, infrared, or semiconductor systems, apparatus, elements, or a combination any of the above. A more specific example of the computer readable storage medium may include but is not limited to: electrical connection with one or more wire, a portable computer disk, a hard disk, a random access memory (RAM), a read only memory (ROM), an erasable programmable read only memory (EPROM or flash memory), a fibre, a portable compact disk read only memory (CD-ROM), an optical memory, a magnet memory or any suitable combination of the above. In the present disclosure, the computer readable storage medium may be any physical medium containing or storing programs which can be used by a command execution system, apparatus or element or incorporated thereto. In the present disclosure, the computer readable signal medium may include data signal in the base band or propagating as parts of a carrier, in which computer readable program codes are carried. The propagating signal may take various forms, including but not limited to: an electromagnetic signal, an optical signal or any suitable combination of the above. The signal medium that can be read by computer may be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium including but not limited to: wireless, wired, optical cable, RF medium etc., or any suitable combination of the above

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion comprising one or more executable instructions for implementing specified logic functions. It should also be noted that, in some alternative implementations, the functions denoted by the blocks may occur in a sequence different from the sequences shown in the figures. For example, any two blocks presented in succession may be executed, substantially in parallel, or they may sometimes be in a reverse sequence, depending on the function involved. It should also be noted that each block in the block diagrams and/or flowcharts as well as a combination of blocks may be implemented using a dedicated hardware-based system executing specified functions or operations, or by a combination of a dedicated hardware and computer instructions.

The units or modules involved in the embodiments of the present disclosure may be implemented by means of software or hardware. The described units or modules may also be provided in a processor, for example, described as: a processor, comprising a search path removing unit, and an acoustic model training unit, where the names of these units or modules do not in some cases constitute a limitation to such units or modules themselves. For example, the search path removing unit may also be described as “a unit for removing a high-delay search path from all search paths in training an acoustic model by using a connectionist temporal classification criterion.”

The above description only provides an explanation of the preferred embodiments of the present disclosure and the technical principles used. It should be appreciated by those skilled in the art that the inventive scope of the present disclosure is not limited to the technical solutions formed by the particular combinations of the above-described technical features. The inventive scope should also cover other technical solutions formed by any combinations of the above-described technical features or equivalent features thereof without departing from the concept of the disclosure. Technical schemes formed by the above-described features being interchanged with, but not limited to, technical features with similar functions disclosed in the present disclosure are examples.

What is claimed is:

1. A method for training an acoustic model, comprising:
removing a high-delay search path from all search paths used in training an acoustic model by using a connectionist temporal classification (CTC) criterion, the high-delay search path being a search path having a state output delay greater than a delay threshold; and
training the acoustic model using search paths among the all search paths having the state output delay smaller than the delay threshold and other than the high-delay search path.

2. The method according to claim 1, wherein the removing the high-delay search path from the all search paths used in training the acoustic model by using the connectionist temporal classification criterion comprises:
adding a strong delay control constraint to train the acoustic model by using the connectionist temporal classification criterion, the strong delay control constraint being used for reserving the search paths having the state output delay smaller than the delay threshold in the all search paths.

3. The method according to claim 2, wherein the training the acoustic model using search paths among the all search paths having the state output delay smaller than the delay threshold and other than the high-delay search path comprises:
optimizing the acoustic model by maximizing, using the connectionist temporal classification criterion, a sum of probabilities of search paths corresponding to a target sequence in the search paths having the state output delay smaller than the delay threshold, the target sequence being a predicted labeling sequence identical to a reference labeling sequence.

4. The method according to claim 3, further comprising:
receiving a voice input by a user by using the trained acoustic model and determining an optimal search path, the delay of each state output in the optimal search path being smaller than the delay threshold.

5. An apparatus for training an acoustic model, comprising:
at least one processor; and
a memory storing instructions, the instructions when executed by the at least one processor, cause the at least one processor to perform operations, the operations comprising:
removing a high-delay search path from all search paths used in training an acoustic model by using a connectionist temporal classification criterion, the high-delay search path being a search path having a state output delay greater than a delay threshold; and
training the acoustic model using search paths among the all search paths having the state output delay smaller than the delay threshold and other than the high-delay search path.

6. The apparatus according to claim 5, wherein the removing the high-delay search path from the all search paths used in training the acoustic model by using the connectionist temporal classification criterion comprises:
adding a strong delay control constraint to train the acoustic model by using the connectionist temporal classification criterion, the strong delay control constraint being used for reserving a search path whose state output delay smaller than the delay threshold in the all search paths.

7. The apparatus according to claim 6, wherein the training the acoustic model on the basis of the search path whose state output delay smaller than the delay threshold other than the high-delay search path in the all search paths comprises:
optimizing the acoustic model by maximizing, using the connectionist temporal classification criterion, a sum of probabilities of search paths corresponding to a target sequence in the search paths having the state output delay smaller than the delay threshold, the target sequence being a predicted labeling sequence identical to a reference labeling sequence.

8. The apparatus according to claim 7, wherein the operations further comprises:
receiving a voice input by a user by using the trained acoustic model and determining an optimal search path, the delay of each state output in the optimal search path being smaller than the delay threshold.

9. A non-transitory computer medium, storing a computer program, wherein the program, when executed by a processor, causes the processor to perform operations, the operations comprising:
removing a high-delay search path from all search paths used in training an acoustic model by using a connectionist temporal classification (CTC) criterion, the high-delay search path being a search path having a state output delay greater than a delay threshold; and
training the acoustic model using search paths among the all search paths having the state output delay smaller than the delay threshold and other than the high-delay search path.
